(19) United States
(12) Patent Application Publication
(10) Pub. No.: US 2007/0296860 A1
(43) Pub. Date: Dec. 27, 2007

(54) Data Insertion Techniques for Expanding Information Capacity of Existing Communication Systems

(75) Inventors: Wonzoo Chung, Kent, WA (US); Christopher D. Long, Maple Valley, WA (US); Thomas J. Endres, Seattle, WA (US)

Correspondence Address: PERKINS COIE LLP;PATENT-SEA, P.O. BOX 1247, SEATTLE, WA, 98111-1247, US

(73) Assignee: DOTCAST, INC.

(21) Appl. No.: 11/578,479

(22) PCT Filed: Apr. 15, 2005
(86) PCT No.: PCT/US05/12856

§ 371 Date: Aug. 16, 2007

Related U.S. Application Data
(60) Provisional application No. 60/562,713, filed on Apr. 16, 2004.

(51) Int. Cl. H04N 7/00

(52) U.S. Cl. 348/486

(57) ABSTRACT

Methods and apparatus are described for inserting data in a communications system, such as in an existing analog communications system, using quadrature amplitude modulation (QAM) with in-phase analog signals and quadrature data signals. These methods can minimize the distortion to the analog signals while maximizing the data signal strength. The data signals may be sub-modulated on a subcarrier frequency (201) such that the data signals do not interfere with the analog signal detectors in the analog signal receivers, and may be processed with an abatement filter (202) to mitigate the distortion due to Nyquist mismatch in the receiver. The injection phase of data signals may be determined (206) by adaptive algorithms, using a monitor analog signal receiver (103).

### CROSS-REFERENCE TO RELATED APPLICATION(S)

The present application claims priority to U.S. Provisional Patent Application No. 60/562,713, filed Apr. 16, 2004. It is also related to U.S. patent application Ser. No. 09/062,225, filed Apr. 17, 1998, now U.S. Pat. No. 6,433,835, Issued August 13, 2002 entitled “EXPANDED INFORMATION CAPACITY FOR EXISTING COMMUNICATION TRANSMISSION SYSTEMS”; PCT Application No. PCT/US1999/08513, filed Jun. 16, 1999 entitled “EXPANDED INFORMATION CAPACITY FOR EXISTING COMMUNICATION TRANSMISSION SYSTEMS”; U.S. patent application Ser. No. 10/319,671, filed Aug. 9, 2002 entitled “EXPANDED INFORMATION CAPACITY FOR EXISTING COMMUNICATION TRANSMISSION SYSTEMS”; PCT Application No. PCT/US2003/029423, filed Sep. 17, 2003 entitled “ADAPTIVE EXPANDED INFORMATION CAPACITY FOR TELEVISION COMMUNICATIONS SYSTEMS”; U.S. patent application Ser. No. 10/246,084, filed Sep. 18, 2002 entitled “ADAPTIVE EXPANDED INFORMATION CAPACITY FOR COMMUNICATIONS SYSTEMS”; U.S. patent application Ser. No. 10/255,799, filed Sep. 25, 2002 entitled “CABLE TELEVISION SYSTEM COMPATIBLE BANDWIDTH UPGRADE USING EMBEDDED DIGITAL CHANNELS”; and PCT Application No. PCT/US2003/030327, filed Sep. 24, 2003 entitled “CABLE TELEVISION SYSTEM AND METHOD FOR COMPATIBLE BANDWIDTH UPGRADE USING EMBEDDED DIGITAL CHANNELS”.

### BACKGROUND

The demands for higher information rate over a fixed bandwidth channel have created new data communication services utilizing existing infrastructures that are dedicated to analog signals. One such service is broadcasting multi-media digital data over the analog TV signals reusing TV infrastructures. The presence of TV transmitters in most major cities allows building data-broadcasting networks with low cost.

Among possible ways to exploit TV spectrum to insert digital data is dNTSC, which is digital data over NTSC (National Television Standards Committee). This technique is not only applicable to the NTSC systems, but also to other TV standards such as PAL (Phase-Alternating Line), as described in “Expanded information capacity of existing communication transmission systems” by Hartson et. al. (U.S. Pat. No. 6,433,835). According to reference, the dNTSC system reuses the redundant TV spectrum to embed the data as a quadrature component to the visual AM carrier.

One of the priorities of a communications system expanding information capacity of an existing analog communication system is not to disrupt the existing service. To achieve this goal, a system for inserting digital data as quadrature component to the in-phase analog signals, such as the above dNTSC system, may have the following three features:

1—the data signals can be inserted with a phase orthogonal to the video signals so that the video signals become in-phase and the data signals become quadrature;

213 the data signals can be pre-processed by a filter matched to the device in the analog receiver, thus restoring real-valued signals from intermediate frequency (IF) vestigial side band (VSB) signals to prevent cross-talk between the quadrature data signals and in-phase analog signals, for example, IF Nyquist filters in standard TV receivers; and

3—the analog signal receivers can be equipped with a fully synchronous detector (e.g. phase locked loop with narrow bandwidth) to separate in-phase analog signals from the composite signals.

The above features maintain the orthogonality between the quadrature data and the in-phase video through an analog signal detector. Therefore, the analog signal detector will be able to extract the in-phase analog signals without the interference of data signals.

In any implementation, employing the above three features is a challenging task. First, the modulated video signals available as RF signals whose phase varies over time make detection of the absolute phase a non-trivial task. Second, the characteristics of a device for restoring analog signals from the IF VSB signals may vary depending on the receiver. For example, the impulse responses of IF Nyquist filters in TV receivers vary depending on the TV manufacturers. Thus, a transmitter generating data signals optimized for television receivers from a certain manufacturer may cause severe distortion to television receivers from other manufacturers. Finally, most of the analog signal receivers do not use a fully synchronous detector. Thus, perfect separation between the in-phase analog signals and the quadrature data signals is not feasible in general, and consequently the analog signals are distorted by the data signals.

To successfully use analog TV signals for dNTSC services, a system must maximize the strength of the data signals and, at the same time, suppress the distortion to TV receivers that results from the digital data. These two conflicting goals can be achieved by digital signal processing schemes that pre-distort the analog signals or the data signals to meet the above three requirements at a satisfactory level.

Hartson et. al., in “Expanded Information Capacity For Existing Communication Transmission Systems” (U.S. Pat. No. 6,433,835), have developed a solution for the dNTSC systems, dealing with the fact that video detectors in analog signal receivers are not fully synchronous. Hartson's solution has been further developed in “Adaptive Expanded Information Capacity For Communication Systems” by Long et. al. (U.S. CIP application Ser. No. 10/246,084). Under the assumption that most video detectors in television receivers behave similarly to an envelope detector, the strength of in-phase video signals is adjusted depending on the data signal so that the resulting complex magnitude of the in-phase video and the quadrature data is close to the magnitude of the original video signals.

This approach exhibits a drawback, since the envelope detector is an obsolete technique and rarely used. Nowadays, most TV receivers use a quasi-synchronous detector, which behaves as an envelope detector for the low frequency components (around a few hundred KHz) and as a fully synchronous detector for the high frequency components. The prior art is targeted for only a small low frequency portion of the video, and introduces inevitable distortion to the majority of high frequency components for a quasi-synchronous detector. Furthermore, prior systems require interception and processing of video signals, which demands high sampling rate and consequently complicated modulation apparatus.

There is a need for a system that overcomes the above problems, as well as providing additional benefits.

### BRIEF DESCRIPTION OF THE DRAWINGS

FIG. 1 illustrates a dNTSC system including transmitter, analog (TV) signal receiver, and data receiver;

FIG. 2 shows an embodiment of the invention, showing DSP blocks pre-processing data before insertion, including quadrature AM (QAM) sub-modulation, abatement, and injection phase estimator blocks for the dNTSC system;

FIG. 3 illustrates a spectral relation between dNTSC data and NTSC video in baseband in accordance with one embodiment of the invention;

FIG. 4 is a block diagram of the abatement filter in accordance with the one embodiment of invention;

FIG. 5 is a block diagram of monitor analog signal receiver in accordance with one embodiment of the invention;

FIG. 6 is a block diagram of phase detection algorithm in the monitor analog signal receiver in accordance with one embodiment of the invention;

FIG. 7 is a block diagram o f an alternative embodiment of phase detection in the monitor analog signal receiver in accordance with one embodiment of the invention;

FIG. 8 is a block diagram of the injection phase estimator in accordance with one embodiment of the invention;

FIG. 9 is a block diagram of an alternative embodiment of the injection phase estimator in accordance with one embodiment of the invention;

FIG. 10 is a block diagram of another alternative embodiment of the injection phase estimator in accordance with one embodiment of the invention;

FIG. 11 illustrates architecture of a radio frequency (RF) injection approach;

FIG. 12 illustrates an intermediate frequency (IF) injection approach; and

FIG. 13 illustrates architecture of a baseband (BB) injection approach.

### DETAILED DESCRIPTION

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

The described embodiments present three data insertion techniques to meet the above three mentioned requirements of the digital data systems broadcasting over analog communication links, comprising: a data sub-modulation technique, an abatement technique overcoming disadvantages of prior systems, and injection phase estimation techniques. The disclosed systems, methods, and apparatus pre-processes data signals, which consequently simplifies the transmitter compared to prior systems.

In some embodiments, data signals are modulated onto a subcarrier such that data signals exist outside of the tracking bandwidth of phase detectors in analog signal receivers, which allows conventional detectors in analog signal receivers to behave as fully synchronous detectors. Furthermore, the modulated data signals are processed by a complex abatement filter that minimizes a metric computed for maximizing data power and, at the same time, minimizes distortion of the analog signals due to the data. Finally, modulated and filtered data signals are injected to analog signals with a phase adjusted by an adaptive algorithm based on analog signals from a monitor analog signal receiver to ensure orthogonality between quadrature data signals and in-phase analog signals.

The detailed description uses dNTSC as an example. The presented methods and apparatus can be applied to any communication system inserting data signals as quadrature component of existing analog signals, such as cable TV, PAL TV, VSB AM radio, etc.

DNTSC Transmission System Overview

Unless described otherwise below, aspects of the invention may be practiced with conventional systems. Thus, the construction and operation of the various blocks shown in the Figures may be of conventional design, and need not be described in further detail herein to make and use the invention, because such blocks will be understood by those skilled in the relevant art. One skilled in the relevant art can readily make any modifications necessary to the blocks in these Figures based on the detailed description provided herein.

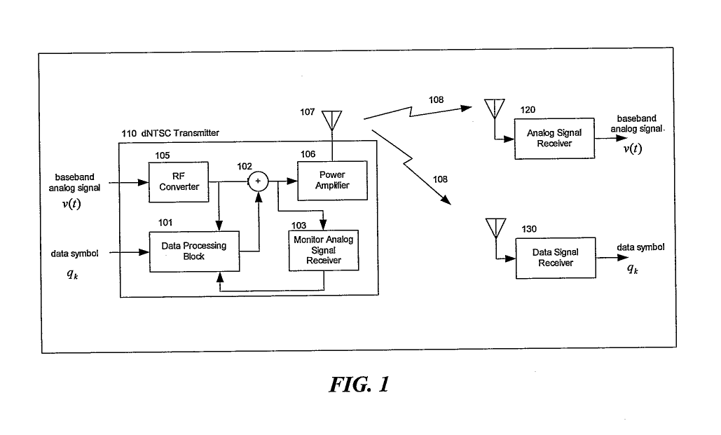

FIG. 1 describes an overall dNTSC system. A transmitter 110 consists of existing analog signal infrastructures: an RF converter 105, a power amplifier 106, and additional data inserting devices. In particular, it includes a data processing block 101, an adder 102, and a monitor analog signal receiver 103. A conventional analog TV signal v(t) is converted to an RF signal v_{RF}(t) by the RF converter 105 and is summed with a data signal (output of the data processing block 101) at the adder 102.

Meanwhile, digital data symbols {qₖ} are processed at the data processing block 101. The output of the data processing block 101 is added to the video signal (output of the RF converter 105) at the adder 102. The output of adder 102 is partly fed to the monitor analog receiver 103, and amplified by the power amplifier 106 and transmitted through an antenna or output port 107. The monitor receiver 103 generates reference signals for the data processing block 101. An antenna or output port of 107 is coupled to a medium 108, which can be air or cable lines. An analog signal receiver 120 demodulates the conventional analog TV signal v(t), and a data signal receiver 130 demodulates the inserted data signal {qₖ}.

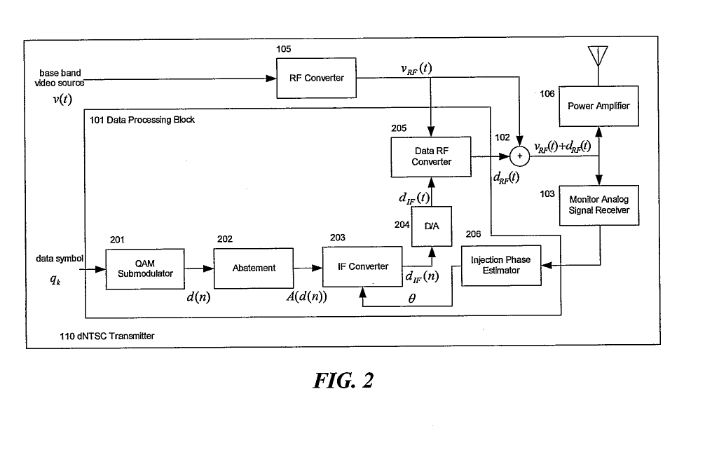

FIG. 2 describes suitable structure of a dNTSC transmitter, in detail, with respect to an embodiment of the invention. The data symbols are sequences of complex numbers {qₖ} drawn from a finite alphabet set whose elements represent information bits. In QAM Sub-Modulator block 201, these symbols are first pulse-shaped by a digital square root raised cosine pulse p(t) of a roll-off factor α, and digitally quadrature amplitude modulated onto a subcarrier f_{sub}, with a symbol rate T_{q} at the sampling rate T_{d}. Mathematically, output d(n) of the QAM Sub-Modulator is given by:

$$d ( n ) = {\sum }_{k = - ∞}^{∞} Re ( {q}_{k} ) p ( n {T}_{d} - k {T}_{q} ) cos ( 2 π {f}_{sub} {T}_{d} n ) - {\sum }_{k = - ∞}^{∞} Im ( {q}_{k} ) p ( n {T}_{d} - k {T}_{q} ) sin ( 2 π {f}_{sub} {T}_{d} n ) , \qquad ( 1 )$$

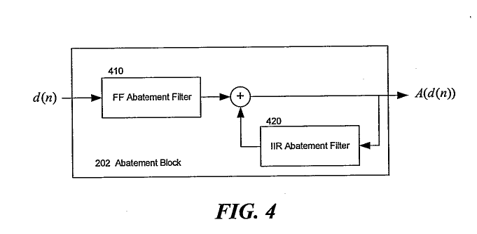

The QAM Sub-Modulator 201 output d(n) is real-valued and treated as a baseband signal. d(n) is processed by a complex linear abatement filter (FIG. 4) in abatement block 202 and becomes complex valued, denoted by A(d(n)), as explained below. Then the complex-valued A(d(n)) is digitally up-converted to intermediate frequency by an IF carrier frequency f_{IF} with an injection phase θ in IF converter 203 and with a gain factor G, whose output can be written as:
d_{IF}(n)=GRe(A(d(n)) cos (2πf_{IF}T_{d}n+θ)−GIm(A(d(n) sin (2πf_{IF}T_{d}n+θ) (2)

The digital data IF signal d_{IF}(n) is converted to the analog signal d_{IF}(t), by an D/A converter 204. The baseband real-valued video signal v(t) is up-converted to radio frequency in the RF converter 105 as a part of the analog signal transmitter system. Data RF converter block 205 takes the analog data IF signal d_{IF}(t) and RF video signal V_{RF}(t) from the RF converter 105, and up-converts data IF signal d_{IF}(t) into the RF signal d_{RF}(t) with the same carrier frequency and phase as the video RF signals using a phase locked loop (PLL). The analog RF signalv_{RF}(t) and the data RF signal d_{RF}(t) are summed in the adder 102. The output of adder 102 is sent to the power amplifier 106 to be transmitted.

RF Injection

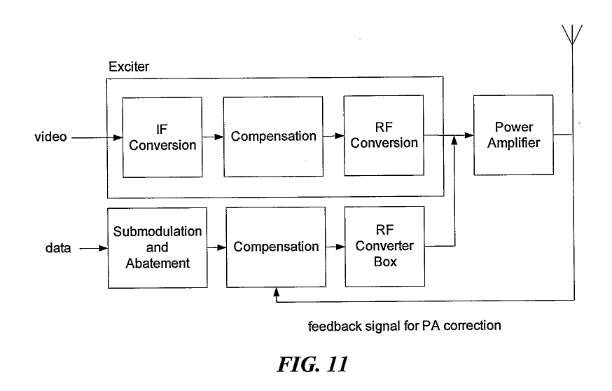

FIG. 11 illustrates the architecture of an existing RF injection approach. In such architecture the data signal is processed by the sub-modulation block and the abatement block and is later compensated by a separate non-linear distortion compensation block with a feedback signal from the PA output. Since there is often mismatch between data and video compensation, the resulting error would introduce additional data leakage to the video signal and will degrade the video quality at the TV receiver.

IF Injection

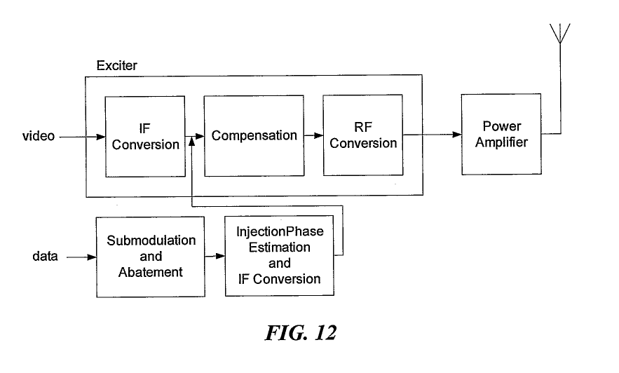

FIG. 12 describes an IF injection approach. In this diagram, IF data is not compensated separately, but is combined with video in IF before going through the video compensation mechanism. In this approach the capability of compensation is limited by the video compensator, where the compensation is usually implemented by old analog technology. Since the mismatch in video and data compensation methods for RF injection creates serious problems in a PA, this IF injection method usually improves video quality despite the poor compensation performance of the video compensator in the Exciter.

BB Injection

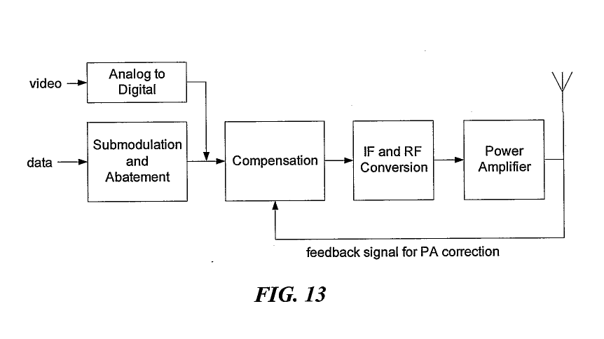

FIG. 13 describes the suggested baseband injection approach. Both the video and the data signals are processed digitally and combined at baseband. Notice that in this baseband digital injection approach, the injection phase estimation is not needed and orthogonality between signals results. The combined video digital signal is compensated by an analog or preferably a digital compensator, which has superior performance than the compensator of the Exciter. Among the advantages of this baseband combining method are the orthogonality between data and video without the need for injection phase estimation, and a powerful digital PA compensation.

Sub-Modulator Block

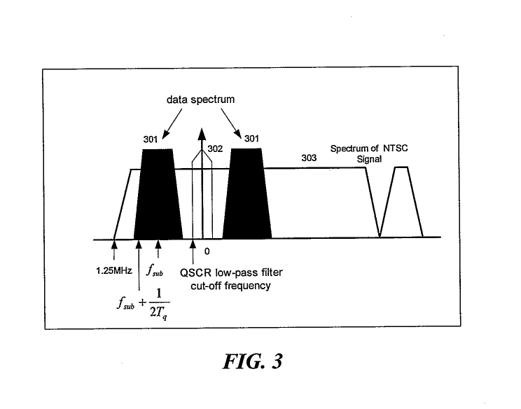

The Sub-Modulator block 201 sets the subcarrier frequency f_{sub} such that the modulated data does not interfere with the video detectors in TV receivers, depicted in FIG. 3. Currently, most TV receivers are equipped with a quasi-synchronous carrier recovery (QSCR) 302 detector for video detection. QSCR 302 detector use a low pass filter with a cut-off frequency of a few hundred KHz, referred to as f_{QSCR}, to extract IF carrier signal component, and use a limiter to generate a reference carrier as described in “An Integrated Video IF Amplifier and PLL Detection System” by Long et al in IEEE Trans. Consumer Electron, vol. CE-28, pp. 168-183, August 1982.

When data signals 301 do not interfere with the QSCR 302 low pass filter as illustrated in FIG. 3, a QSCR recovers the phase based only on video signals 303. Hence, the data component or signals 301 can be separated as if passed through a fully synchronous detector. Therefore, adequate choice of f_{sub}, described by the following formulas, obviates the need for the data abatement schemes in prior systems. On the other hand, f_{sub} can not be an arbitrary large since the data should be contained in a 1.25 MHz lower VSB cut-off frequency as shown in FIG. 3. Therefore, a range of f_{sub} is determined by

$${f}_{QSCR} + \frac{1 + α}{2 {T}_{q}} < {f}_{sub} < 1.25 MHz - \frac{1 + α}{2 {T}_{q}} , \qquad ( 3 )$$

where α is a roll-off factor of a pulse shape filter and T_{q} is the symbol rate. A suitable choice of f_{sub} is about 852 KHz, T_{q}=613 KHz, and α=0.25, assuming f_{QSCR} does not exceed 500 KHz.
abatement Block

TV receivers use an IF filter called a Nyquist filter to restore full frequency band from the VSB signal. Since the IF Nyquist filter is a complex valued filter in the baseband, IF Nyquist filter introduces a cross-talk between the in-phase analog TV signal and the quadrature data signal. Furthermore, the impulse response of the Nyquist filter at baseband varies substantially depending on receivers from different manufacturers. To mitigate the cross-talk in average, the abatement block 202 pre-distorts data signals with an abatement filter. A criteria for obtaining an abatement filter is describe below.

The restored video signal from the dNTSC signal by a QSCR detector in conventional TV receivers, sampled at the sampling rate T_{d}, is given by:
video=v(n)−IM(N(n)\textcircled{×}A(n)\textcircled{×}d(n)), (4)
where N(n) and A(n) denote the discrete time domain impulse response of the Nyquist filter at baseband and a discrete time domain impulse response of the abatement filter, respectively, and where \textcircled{×}denotes the convolution operator.

The data signal demodulated from the dNTSC signal by the data receiver 130 is given by:
data=Re(A(n)\textcircled{×}d(n)). (5)

The abatement filter A(n) is constructed to minimize data leakage in the video and, at the same time, to maximize power of the data. This may be achieved by an optimization based on a quadratic cost function generated from video leakage and data power.

Denoting a set of impulse responses of baseband equivalent Nyquist filters as {N₀(n), N₁(n), . . . N_{K-1}(n)}, coefficients of a feed forward (FF) filter 410 and the infinite impulse response (IIR) filter 420 in FIG. 4 are chosen based on the following criteria which jointly minimizes data leakage to the video and maximizes data energy;

$${A}^{opt} = arg {min}_{A} ( {\sum }_{k = 0}^{K - 1} {α}_{k} J ( Im ( {N}_{k} ( n ) ⊗ A ( n ) ) - β J ( Re ( A ( n ) ) ) , \qquad ( 6 )$$

where αₖ, β are weights which can be determined empirically or based on the statistics of the Nyquist filter population in an area, and J is a cost function given by:
J(x)=xDΛD^{T}x^{T}, (7)
where x^{T} denotes the transpose of input vector x, D is a basis matrix, and Λ is a diagonal matrix whose diagonal entries are [λ₀, . . . , λ_{N}_{_{Λ}}₋₁].

When D and Λ are the identity matrix, then J becomes the conventional l−norm. When D is a discrete Fourier transform (DFT) matrix, J represents a frequency domain decomposition cost function. J can be more generalized using a wavelet bases transformation matrix to optimize A(n) with respect to human perception as described in “Computational Signal Processing with Wavelets” by Teolis, Birkhaeuser, 1998.

Since the above equation (6) for A^{opt} is a quadratic function independent from the choice of W and a, finding A^{opt} is a classical quadratic optimization problem, which can be solved with a direct matrix inversion or a numerical search algorithm. For an abatement filter matched to a single Nyquist filter N(n), an optimal abatement filter satisfying the above criterion is given by a complementary Nyquist filter, i.e. the feed forward abatement filter 410 is the complex conjugate of N(n) and the IIR portion from IIR filter 420 is zero.

Monitor Analog Signal Receiver Block

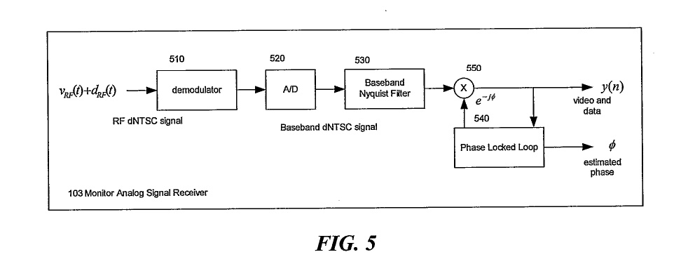

Monitor Analog Signal Receiver 103 provides a feedback signal, derived from the demodulated video signals, for finding an optimal injection phase. First, the RF output of the adder 102 is directly demodulated to baseband by a demodulator 510, as illustrated FIG. 5. The output of the demodulator 510 is sampled by an A/D converter 520. The output of the A/D converter 520 is then processed by a baseband Nyquist filter 530. For this Monitor Analog Signal Receiver 103, a complementary abatement filter (i.e. N(n)=conj(A(n))) is recommended for the baseband Nyquist filter 530 to eliminate distortion from other sources.

The output of the Nyquist filter 530 should contain the baseband video signal in the real component and the data signal in the imaginary component, but may suffer from an unknown phase rotation. To correct the phase rotation a phase locked loop (PLL) 540 is employed. The PLL 540 can be implemented with a digital version of a conventional PLL. However, in accordance with this aspect, two different digital schemes are presented to obtain the phase and recover video signals.

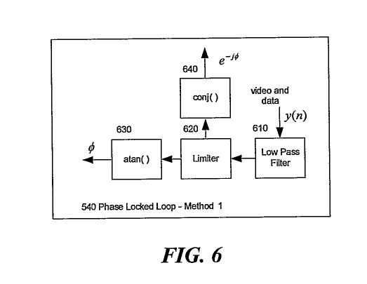

The first method is a replica of a QSCR detector as illustrated FIG. 6. The output of the Nyquist filter 530 is passed through a low pass filter 610. The output of the low pass filter 610 becomes unit norm by being divided by its magnitude, y=z/|z|, in a limiter 620. Phase information is extracted from the output of the limiter 620 by applying arctangent function in atan block 630. The complex conjugate 640 of the limiter output is multiplied to the Nyquist filter output at a multiplier 550.

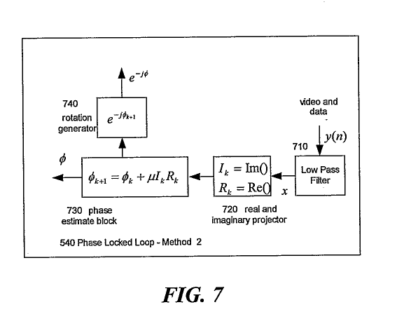

The second method is an adaptive algorithm maximizing the energy of the real component of the Nyquist output as illustrated in FIG. 7. The output of the Nyquist filter 530 is passed through a low pass filter 710 to eliminate the data component. Here, this method maximizes the following cost function adaptively:
J(Φ)=E∥Re(x)∥², (8)
where x denotes the output of the low pass filter 710. An adaptive algorithm to update the phase to maximize the above cost function (8) is given by:
Φₙ₊₁=Φₙ+μRe(x)Im(x), (9)
where μ is a step size. The real and imaginary components of the low pass filter 710 output are extracted at a real and imaginary projector 720. The output of the real and imaginary projector 720 is used to update a phase estimate at a phase estimate block 730 with the above update algorithm (9). Finally, based on the updated phase estimate, a complex number representing the negative of the updated phase estimate is generated at a rotation generator 740. The output of the rotation generator 740 is multiplied to the output of the Nyquist filter 530 rotated at the multiplier 550.
Injection Phase Estimator Block

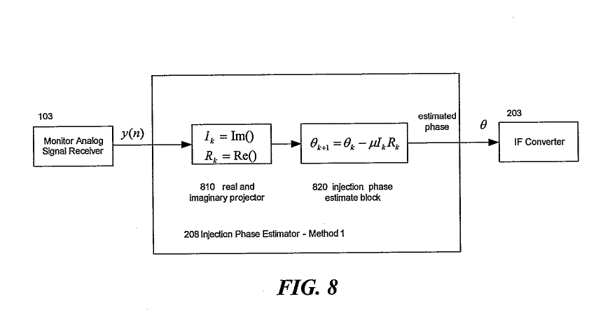

The Injection Phase Estimator block 206 estimates an optimal injection phase to minimize the distortion of data to video. FIGS. 8-10 describe three different schemes for implementing the Injection Phase Estimator 206.

The first method, illustrated in FIG. 8, is to adaptively find the injection phase while minimizing residual data power in the video signals. With injection phase θ and unknown phase shift φ, the output of the Nyquist filter 530, denoted by y(n), is given by
y(n)=v(n)+e^{j(θ+φ)}A\textcircled{×}d(n). (10

The optimal injection phase θ is one that minimizes the energy of the real component of y(n), which may be represented by the following cost function:
J(θ)=E∥Re(y(N))∥². (11)

An adaptive algorithm minimizing the above cost function (11) is given by:
θₖ₊₁=θₖ−μθₖRe(y(n))IM(y(n)), (12)
and may be implemented in the following manner: the real component and the imaginary components of the output of the monitor receiver 103 are extracted in a real and imaginary projector 810. The output of the real and imaginary projector 810 is used to update an injection phase estimate θ in block 820 under the above update algorithm (9) with a step-size μ.

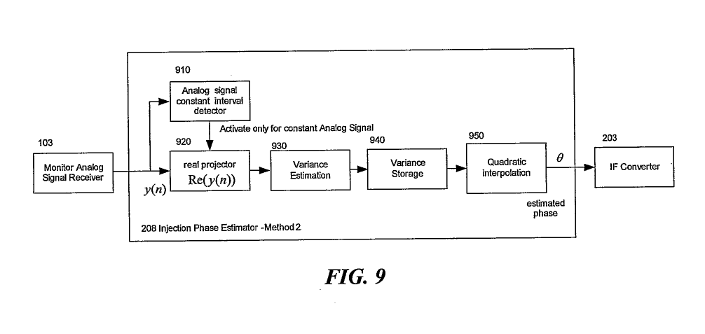

The second method, illustrated in FIG. 9, finds rather indirectly the injection phase based solely on the video signals. The video signals in an NTSC system contain several constant levels, including sync tips. An analog signal constant level detector 910 thus detects these constant intervals. For a given injection phase θ, once a constant interval with v(n)=C is detected, a variance J_{c}(θ) of the real component of the output of the monitor receiver 103 y(n) at the interval is calculated by:

$${J}_{C} ( θ ) = {\sum }_{\{ n \vert y ( n ) = C \}} {( Re ( y ( n ) ) - \frac{1}{{N}_{c}} {\sum }_{\{ n \vert y ( n ) = C \}} Re ( y ( n ) ) )}^{2} , \qquad ( 13 )$$

in a variance estimation block 930 followed by a real projector 920, where N_{c} is the number of samples at interval v(n)=C. The variance J_{C}(θ) is evaluated at various constant values C, e.g. J_{C}_{₁}, . . . J_{C}_{_{M}}, and these variances are weighted to produce a cost function J(θ) in a variance estimation block 930:
J(θ)=γ₁J_{C}_{₁}(θ)+ . . . +γ_{M}J_{C}_{_{M}}(θ), (14)
where γ₁, . . . , γ_{M} are the weights.

The cost function J(θ) is evaluated for various θ, e.g. {J(θ₁), J(θ₂), . . . J(θ_{K-1})}, and stored in a variance storage block 940. The optimal θ, is the one that minimizes J(θ). Since the cost-function is only for finite observation points, the optimal θ is estimated from {J(θ₁), J(θ₂), . . . J(θ_{K-1})} using a quadratic interpolation at a quadratic interpolation block 950. For example, assuming that J(θ₀)≦J(θ₁)≦J(θ₂) for three observation points, θ₀, θ₁, θ₂, the injection phase estimate is given by:

$$θ = {θ}_{1} + \frac{1}{2} \frac{J ( {θ}_{2} ) - J ( {θ}_{0} )}{2 J ( {θ}_{1} ) - J ( {θ}_{2} ) - J ( {θ}_{0} )} . \qquad ( 15 )$$

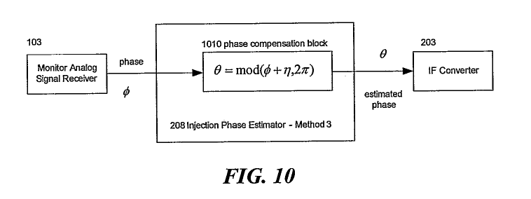

The third method, illustrated in FIG. 10, is relatively simple. The estimated phase, Φ, from the monitor analog receiver 103 is compensated with a fixed phase η measured empirically in a phase compensation block 1010 to produce the injection phase orthogonal to the video signals.

Three different implementations of data injection into a video signal are described below: a radio frequency (RF) injection of data to video, an intermediate frequency (IF) injection of data to video, and a baseband (BB) injection of data to video. Data and video exhibit different statistical properties, but face the same non-linear distortion due to the power amplifier (PA) 106. Usually, a video signal has its own compensation mechanism inside of an “Exciter.” Thus, in an RF injection approach, data is compensated separately with its rather complicated non-linear compensation mechanism.

In the presence of a severely distorting PA, the RF injection approach often fails to satisfy the required video quality for TV receivers. In order to overcome this problem due to separated non-linear compensation mechanisms for the video and data, several alternative approaches have been devised and proven to be useful.

Conclusion

While specific circuitry may be employed to implement the above embodiments, some aspects can be implemented in a suitable computing environment. Although not required, some aspects may be implemented as computer-executable instructions, such as routines executed by a general-purpose computer, e.g., a server computer, wireless device or personal computer. Those skilled in the relevant art will appreciate that the embodiments can be practiced with other communications, data processing, or computer system configurations, including: Internet appliances, hand-held devices (including personal digital assistants (PDAs)), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer” are generally used interchangeably herein, and refer to any of the above devices and systems, as well as any data processor.

Aspects of the invention can be embodied in a special purpose computer or data processor that is specifically programmed, configured, or constructed to perform one or more of the computer-executable instructions explained in detail herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list, and any combination of the items in the list.

The above detailed description of the embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways.

Also, while processes or blocks are at times shown as being performed in series, these processes or blocks may instead be performed in parallel, or may be performed at different times. Where the context permits, words in the above Detailed Description using the singular or plural number may also include the plural or singular number respectively.

The teachings provided herein can be applied to other systems, not necessarily the system described herein. The elements and acts of the various embodiments described above can be combined to provide further embodiments. All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the system may vary considerably in its implementation details, while still being encompassed by the invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

All of the above patents and applications and other references, including any that may be listed in accompanying filing papers, as well as the U.S. Provisional Patent Application No. 60/562,716, filed on Apr. 16, 2004 entitled “Symbol Error Based Compensation Methods for Nonlinear Amplifier Distortion,” assigned to Dotcast, (Attorney Docket No. 41352-8007US) and the U.S. Provisional Patent Application No. 60/562,814, filed on Apr. 16, 2004 entitled “Remote Antenna And Local Receiver Subsystems For Receiving Data Signals Carried Over Analog Television,” assigned to Dotcast, (Attorney Docket No. 41352-8008US), are incorporated herein by reference. Aspects of the invention can be modified, if necessary, to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. Accordingly, the inventors reserve the right to add additional claims after filing the application to pursue such additional claim forms for other aspects of the invention.

We claim:

1. A method for inserting data signals into an analog video signal of an existing analog television (TV) system, the method comprising:
pulse-shaping data symbols by a digital pulse-shaping filter;
digitally quadrature-amplitude-modulating (QAM) the pulse-shaped data symbols onto a subcarrier to produce a quadrature amplitude modulated data signal, wherein the subcarrier is chosen such that a resulting spectrum of the analog data signal resides within a spectrum of the analog video signal and the data spectrum does not interfere with quasi-synchronous carrier recovery (QSCR) detectors at TV receivers that receive the analog video signal;
filtering the quadrature amplitude modulated data signal by a complex linear abatement filter to predistort the quadrature amplitude modulated data signals to minimize distortion to the analog video signals caused by filter mismatches among different filters at TV receivers that receive the analog video signal;
digitally up-converting the filtered data signal to produce an intermediate frequency (IF) digital data signal;
applying a gain factor G to the IF data signal;
injecting a phase θ in the IF data signal, based on feedback information, to maintain orthogonality of the data signal with the analog video signal;
converting the phase injected IF data signal to an analog data signal;
up-converting the analog data signal into an RF data signal, wherein the RF data signal has a substantially similar carrier frequency and phase as the analog video signal;
summing the analog video signal and the RF data signal;
feeding back the summed signal;
estimating the injection phase θ using the fed-back summed signal;
amplifying the summed signal; and
transmitting the amplified summed signal.

2. The method of claim 1, wherein a range of subcarrier frequencies f_{sub}, is determined such that a resulting spectrum of the analog data signal resides within a spectrum of the analog video signal and the data spectrum does not interfere with quasi-synchronous carrier recovery (QSCR) detector at TV receivers that receive transmitted signal, and wherein the range of subcarrier frequency f_{sub}, is determined by:
$${f}_{QSCR} + \frac{1 + α}{2 {T}_{q}} < {f}_{sub} < 1.25 MHz - \frac{1 + α}{2 {T}_{q}} ,$$
where α is a roll-off factor of the pulse shaping, T_{q} is a symbol rate, and f_{QSCR} is a cut-off frequency of a low pass filter used by the QSCR detectors at the TV receivers.

3. The method of claim 1, wherein data symbols are pulse-shaped by a digital square root raised cosine pulse p(t) of a roll-off factor α, the subcarrier is a modulated subcarrier f_{sub} with a symbol rate T_{q} at a sampling rate T_{d}, and data symbols are sequences of complex numbers {qₖ} drawn from a finite alphabet set, and wherein pulse-shaped data symbols d(n) are given by:
$$d ( n ) = {\sum }_{k = - ∞}^{∞} Re ( {q}_{k} ) p ( n {T}_{d} - k {T}_{q} ) cos ( 2 π {f}_{sub} {T}_{d} n ) - {\sum }_{k = - ∞}^{∞} Im ( {q}_{k} ) p ( n {T}_{d} - k {T}_{q} ) sin ( 2 π {f}_{sub} {T}_{d} n ) ,$$

4. The method of claim 1, wherein the IF data signal after up-conversion, injection of phase θ, and application of a gain factor G, is represented by d_{IF}(n), where:
d_{IF}(n)=GRe(A(d(n)) cos (2πf_{IF}T_{d}n+θ)−GIm(A(d(n)) sin (2πf_{IF}T_{d}n+θ),
where A(d(n)) denotes pulse-shaped data symbols d(n) after passing through an abatement filter, f_{IF} is an IF carrier frequency for converting A(d(n)) to intermediate frequency, and T_{d} is a sampling rate.

5. The method of claim 1, wherein the abatement filter maximizes power of the data signal and minimizes cross-talk between an in-phase video signal and the quadrature modulated data signal caused by IF Nyquist filters at TV receivers.

6. The method of claim 1, wherein estimating the injection phase θ using the fed-back summed signal comprises:
demodulating the fed-back summed signal to baseband video and data signals;
sampling the demodulated signal by an Analog-to-Digital (A/D) converter;
filtering the A/D converted signal by a baseband Nyquist filter;
estimating a phase rotation Φ caused by the Nyquist filter by analyzing output of the Nyquist filter in a phase-locked-loop (PLL);
forming a baseband sum of the baseband video and data signals by multiplying the output of the Nyquist filter and an exponential function of the estimated phase rotation Φ; and
estimating an optimal value of the injection phase θ to minimize distortions to the analog video signal caused by the analog data signal, using the estimated phase rotation Φ or the baseband sum of the baseband video and the data signals.

7. The method of claim 1, wherein the TV system is based on NTSC (National Television Standards Committee) or PAL (Phase-Alternating Line).

8. An apparatus for data injection into transmission links of an analog communication system, the apparatus comprising:
means for modulating data signals onto a subcarrier to produce data signals that are quadrature and substantially orthogonal to in-phase analog signals of the system;
means for preprocessing the data signals to minimize distortion to the analog signals caused by filter mismatches among different filters at analog system signal receivers;
means for injecting a phase θ into the data signals to establish substantial orthogonality between the quadrature data signals and the in-phase analog signals, wherein the means for injecting phase θ includes:
adaptive algorithm means for minimizing data leakage to the analog signals;
interpolation means based on multiple phases for minimizing the data leakage; or
means for directly estimating the injection phase θ from the analog signals; and
means for inserting the data signals into the analog signals.

9. The apparatus of claim 8, wherein the analog signal is based on NTSC (National Television Standards Committee) or PAL (Phase-Alternating Line), and wherein the analog communication system is analog cable TV or a terrestrial analog broadcast.

10. The apparatus of claim 8, further comprising means for estimating the injection phase θ, wherein the means for estimating comprises:
means for monitoring a combination of the data signal and the analog signal to produce a baseband summation and for estimating a phase rotation Φ caused by the monitoring; and
means for estimating an optimal injection phase to establish orthogonality between the quadrature data signals and in-phase analog signals, and for minimizing distortions caused by the data signals based on an output of the means for monitoring.

11. A signal processing system for use with analog signals in an analog communication network, the system comprising:
a data modulator for modulating data signals onto a subcarrier such that the data signals do not interfere with phase detectors of receivers;
a facility for preadjusting phase of the data signals by injecting an estimated corrective phase into the data signals;
a facility for inserting the phase adjusted data signals into the analog signals of the analog communication system; and
an abatement filter, coupled among the data modulator and the phase insertion facility, for preprocessing the data signals, wherein the abatement filter is configured to minimize distortion to the analog signals caused by filter mismatches among different filters of the receivers.

12. The system of claim 11, wherein data modulation is quadrature amplitude modulation (QAM).

13. The system of claim 11, wherein the corrective phase is estimated by:
an adaptive algorithm minimizing data leakage to the analog signals at a point of reception;
interpolation based on data strength associated with multiple phases; or
direct phase estimation from the analog signals.

14. The system of claim 11, wherein the analog communication system is a television system, and wherein a range of subcarrier frequencies f_{sub} is determined to provide a data spectrum within a television video signal spectrum, and wherein the data spectrum substantially does not interfere with a quasi-synchronous carrier recovery (QSCR) detector at the receivers.

15. In a system for inserting data signals into analog television (TV) video signals, a process of quadrature-amplitude-modulating (QAM) data symbols onto subcarriers at baseband frequency for transmission to receivers, the process comprising:
receiving pulse-shaped data symbols; and
digitally quadrature-amplitude-modulating (QAM) the pulse-shaped data symbols onto a subcarrier, wherein:
the subcarrier has a frequency range f_{sub};
the video signals have a video frequency range; and
the subcarrier frequency range f_{sub} of the data signal is within the video frequency range, but is selected to avoid interfering with quasi-synchronous carrier recovery (QSCR) detectors for extracting carrier signal component at the receivers.

16. In a system for inserting data signals into analog television (TV) video signals, a method of estimating and injecting a phase θ into the data signal, the method comprising:
monitoring an RF aggregate signal, including data signals and video signals, wherein the monitoring includes:
demodulating the RF aggregate signal to baseband;
sampling the demodulated signal;
filtering the sampled signal;
estimating a phase rotation Φ, caused by the filtering; and
forming a baseband sum of the video and the data signals by multiplying the filtered signal and a function of the estimated phase rotation Φ; and
estimating an injection phase θ, wherein the injection phase θ is estimated to minimize distortions to the video signal caused by the data signal using the estimated phase rotation Φ or the baseband sum of the video and the data signals.

17. The method of claim 16, wherein estimating the phase rotation Φ includes:
low-pass filtering the baseband sum of the video and the data signals;
dividing the low pass filtered signal by a magnitude of the low pass filtered signal to produce a unit norm; and
computing an arctangent of the unit norm.

18. The method of claim 16, wherein estimating the phase rotation Φ includes:
low-pass filtering the baseband sum of the video and the data signals;
extracting real and imaginary components of the low-pass filtered signals; and
adaptively maximizing the following cost function:
J(Φ)=E∥Re(x)∥²;
where μ is a step size and Φₙ₊₁=101ₙ+μRe(x)Im(x) adaptively updates the phase for maximizing the above cost function and where x denotes the low-pass filtered signal.

19. The method of claim 16, wherein estimating the injection phase θ includes:
extracting real and imaginary components of the baseband sum of the video and the data signals, y(n); and
adaptively minimizing the following cost function:
J(θ)=E∥Re(y(n))∥²,
where μ is a step-size and θₖ₊₁=θₖ−μθₖRe(y(n))Im(y(n)) adaptively updates the injection phase estimate θ for minimizing the above cost function.

20. The method of claim 16, wherein the estimation of the injection phase θ comprises:
detecting a constant interval of the video signal with v(n)=C;
calculating a variance of a real component of the baseband sum of the video and the data signals, y(n), for a given injection phase θ, wherein the variance is calculated by:
$${J}_{C} ( θ ) = {\sum }_{\{ n \vert y ( n ) = C \}} {( Re ( y ( n ) ) - \frac{1}{{N}_{c}} {\sum }_{\{ n \vert y ( n ) = C \}} Re ( y ( n ) ) )}^{2} ,$$
where N_{c} is the number of samples at the interval v(n)=C; evaluating and weighting the variance J_{C}(θ) at various constant values C to produce a cost function J(θ), where γ₁, . . . , γ_{M} are weights and J(θ) is represented by:
J(θ)=γ₁J_{C}_{₁}(θ)+ . . . +γ_{M}J_{C}_{_{M}}(θ);
evaluating the cost function J(θ) for various θ; and
identifying a θ that minimizes J(θ), wherein the θ is estimated from J(θ)s, using a quadratic interpolation.

21. The method of claim 16, wherein the estimation of the injection phase θ includes the estimation of the phase rotation Φ compensated by an empirically measured fixed phase η such that to produce orthogonality.

22. A method for inserting data signals into a television (TV) video signal, the method comprising:
modulating the data signal onto a subcarrier;
filtering the data signal;
converting the analog video signal to a digital video signal;
combining the digital video signal and the data signal at baseband to produce combined signal;
up-converting the combined signal to an intermediate frequency (IF) and an RF signal, or to an RF signal; and
feeding back the combined signal to assist in adjusting the compensation value.

23. The method of claim 22, wherein data modulation is quadrature amplitude modulation (QAM), abatement filter is a complex linear abatement filter, and compensator is either digital or analog, and wherein a compensation factor associated with non-linearity of power amplification is applied to the combined signal.

24. In a system for inserting data signals into analog television (TV) video signals for transmitting a quadrature combination of video signals and data signals to a receiver, an apparatus for predistortion of data symbols, the apparatus comprising:
a feed forward filter;
an infinite impulse response filter; and
an adder for adding an output of the feed forward filter with an output of the infinite impulse response filter to produce predistorted data signals, wherein:
the pre-distorted data signals of the adder are fed back to an input of the infinite impulse response filter; and
coefficients of the feed forward filter and the infinite impulse response filter are chosen to minimize data leakage to the video signals and to maximize energy of the data signals by minimizing a cost function that is based on knowledge of an impulse response of a Nyquist filter at the receiver.

25. The apparatus of claim 24, wherein the coefficients of the feed forward filter and the infinite impulse response filter are chosen based on the following criteria which jointly minimizes data leakage to the video and maximizes data energy:
$${A}^{opt} = arg {min}_{A} ( {\sum }_{k = 0}^{K - 1} {α}_{k} J ( Im ( {N}_{k} ( n ) ⊗ A ( n ) ) - β J ( Re ( A ( n ) ) )$$
where N(n) denotes a discrete time domain impulse response of a baseband equivalent Nyquist filter, A(n) denotes a discrete time domain abatement filter impulse response, {N₀(n), N₁(n), . . . N_{K-1}(n)} denotes a set of impulse responses of baseband equivalent Nyquist filters, αₖ, β are weights determined empirically or based on statistics of the Nyquist filter population in a certain area, and J is a cost function given by:
J(x)=xDΛD^{T}x^{T},
where x^{T} denotes a transpose of an input vector x, D is a basis matrix, and Λ is a diagonal matrix whose diagonal entries are [λ₀, . . . , λ_{N}_{_{Λ}}₋₁], and \textcircled{×} denotes the convolution operator.

26. In a television (TV) signal broadcasting system, a method of inserting data signals into analog TV video signals, the method comprising:
rotating the data signal 90 degrees with respect to a baseband video signal;
forming a baseband sum of video and rotated data signals;
compensating the baseband sum signal to minimize distortion to the video signal, the data signal, or to both;
upconverting the compensated signal;
power amplifying the upconverted signal; and
feeding back a portion of the amplified signal to be utilized for compensating the baseband sum signals.
